(19) United States
(12) Patent Application Publication
(10) Pub. No.: US 2006/0268395 A1
(43) Pub. Date: Nov. 30, 2006

(54) Impurity-based electroluminescent waveguide amplifier and methods for amplifying optical data signals

(75) Inventors: Andrew J. Steckl, Cincinnati, OH (US); Christopher C. Baker, Hillsboro, OR (US); Jason C. Heikenfeld, New Richmond, OH (US)

Correspondence Address: WOOD, HERRON & EVANS, LLP, 2700 CAREW TOWER, 441 VINE STREET, CINCINNATI, OH, 45202, US

(73) Assignee: University of Cincinnati

(21) Appl. No.: 11/311,771

(22) Filed: Dec. 19, 2005

Related U.S. Application Data
(63) Continuation of application No. PCT/US04/21074, filed on Jun. 29, 2004.
(60) Provisional application No. 60/483,710, filed on Jun. 30, 2003.

(51) Int. Cl. H01S 3/00; H04B 10/12

(52) U.S. Cl. 359/341.1

(57) ABSTRACT

Electroluminescent waveguide amplifier and methods for amplifying optical data signals in a fiber optical telecommunications system to achieve signal enhancement that compensates for losses incurred by attenuation, optical splitting, and routing through the optical communication system. The waveguide amplifier (30) includes an electroluminescent active layer (38) having a host medium doped with luminescent dopant atoms capable of amplifying a propagating optical data signal (45) by stimulated emission of photons (41). Confining and insulating cladding layers (36, 40) surround the active layer (38) and confine the propagating optical data signals (45) being amplified to the active layer (38) and cladding layers (36, 40).

### CROSS-REFERENCE TO RELATED APPLICATIONS

This application is a continuation of PCT Application Serial No. PCT/US2004/021074 filed on Jun. 29, 2004 and claims the benefit of U.S. Provisional Application No. 60/483,710 filed on Jun. 30, 2003, the disclosures of which are hereby incorporated by reference herein.

### STATEMENT REGARDING FEDERALLY SPONSORED RESEARCH

The U.S. Government has a paid-up license in this invention and the right in limited circumstances to require the patent owner to license others on reasonable terms as provided for by the terms of Army Research Grant No. DAAD 19-02-2-0014.

### FIELD OF THE INVENTION

The present invention relates to optical fiber telecommunications systems and, in particular, to apparatus and methods for amplifying optical data signals in an optical fiber telecommunications system.

### BACKGROUND OF THE INVENTION

Modern optical fiber telecommunications systems transfer optical data signals over long distances with relatively low loss and minimal attenuation. A modulated light source or light source and modulator comprising a transmitter transmits information-modulated optical data signals at one or more distinct wavelengths over an optical fiber, which conveys the optical data signals to a light receiver. The intensity of the optical data signals is periodically amplified to compensate for signal attenuation from distribution and component-insertion losses. Conventional amplification devices boost the optical data signals without any conversion of the light into an electrical signal.

Rare earth doped glasses in fiber form are a familiar amplification medium in optical fiber communication systems. The most interest has been directed towards erbium-doped fiber amplifiers (EDFA's). Although EDFA's present many advantages and can be used in a wide array of optical fiber telecommunication systems, a significant disadvantage is that EDFA's are not compact structures and typically require an amplifier length on the order of several meters. Erbium-doped waveguide amplifiers (EDWA's), which are related to EDFA's, combine the potential for large optical gains with a relatively small size and the ability to integrate the amplifier with other components such as optical taps (for signal and pump monitoring), splitters and other common integrated optical components on a single platform.

EDFA's and EDWA's operate on the same physical principles. A waveguide glass structure, formed from a material such as silica, phosphate glasses, and soda lime glasses, is doped with atoms of the rare earth erbium (Er). An optical system injects 1.55 μm optical data signals in the C-band to be amplified in the waveguide along with pump light from an optical pumping source, usually a laser, emitting optical radiation typically in the 0.8 μm to 1 μm range. The erbium atoms mediate the transfer of energy from the optical pumping source to the optical data signals via absorption at the pump wavelength and stimulated emission at the signal wavelength, which yields amplification of the light forming the optical data signals.

A principal difficulty with EDWA's, as compared with EDFA's, is that a high gain must be achieved over a short distance, which requires doping the waveguide glass structure with a relatively high optically-active Er concentration. High Er concentrations, however, introduce gain limiting effects, such as cooperative up-conversion interactions between Er ions, and concentration quenching. The pump power of the optical pumping source must be increased to compensate for these limiting effects, which can lead to excited state absorption that dramatically reduces pump efficiency.

Successful integration of waveguide optical amplifiers on a silicon platform necessitates a material system having high amplification capability and increased functionality. Low-cost metro communication systems and high-speed microprocessor integration, among other applications, are contingent upon integrating optical amplifiers with optical components and microelectronics. Unfortunately, the use of EDWA's in such integrated systems is limited primarily by the need for a high Er dopant concentration and the necessity of an optical pumping source.

Semiconductor optical amplifiers (SOA's) provide a compact alternative to EDFA's and EDWA's for light amplification. SOA's have a device structure similar to semiconductor Fabry-Perot laser diodes. However, optical feedback (e.g., the lasing effect caused by reflection between cavity mirrors defining a resonator cavity) is eliminated and low insertion loss is achieved by angle cleaving the input and output facets and applying anti-reflection coatings on the input and output facets. SOA's rely on electrically-stimulated intrinsic bandgap emission, which eliminates the need for an optical pumping source as in EDFA's and EDWA's. The emission wavelength is determined by bandgap engineering, such as by appropriately adjusting the composition of constituent compound semiconductors. Contemporary semiconductor processing has advanced to the point that SOA's can be produced at a significantly lower cost than EDWA's and EDFA's, present a smaller device footprint, and include a smaller parts count.

With reference to FIG. 1, a typical conventional SOA 10 includes an active layer 12 sandwiched between lower and upper confining layers 14, 16 on a single crystal substrate 18, a lower electrode 20 on the substrate 18, a contacting layer 22 covering the upper confining layer 16, and a stripe electrode 24 formed in an oxide layer 26 covering the contacting layer 22. The active layer 12 of the SOA 10 provides electrically-stimulated intrinsic emission from the bandgap valence and conduction levels when sufficient DC voltage or potential is applied across the electrodes 20, 24. The single crystalline semiconducting layers comprising the device heterostructure in the SOA (i.e., active layer 12, confining layers 14, 16 and contacting layer 22) are fabricated by complex epitaxial crystal growth techniques, such as molecular beam epitaxy (MBE) or metallorganic chemical vapor deposition (MOCVD). These growth techniques are very expensive to implement and time consuming so that process throughput is limited. Moreover, the selection of an amplification wavelength is limited by the band-gap of constituent semiconductor material(s).

SOA's have numerous disadvantages that limit their use for light amplification in fiber optic telecommunications systems. For example, low insertion losses are difficult to achieve in SOA's, which limits the coupling efficiency of the optical data signals into and out of the device. The gain of SOA devices is nonlinear and exhibits a polarization dependence due to the device geometry and dimensions. Moreover, it is also not practical to configure an SOA so that the entire amplifying region comprises an optical distribution device, such as integrating the SOA with splitters, multimode interference (MMI) couplers, arrayed waveguide gratings, and the like.

What is needed, therefore, is an amplifier structure and method for amplifying optical data signals transmitted by optical fibers that does not require an optical pumping source for achieving amplification and that has an active layer that can be formed without resort to single crystal growth techniques.

### SUMMARY OF THE INVENTION

According to principles of the present invention, a waveguide amplifier includes an electroluminescent active layer consisting of a host medium doped with luminescent dopant atoms capable of amplifying a propagating optical data signal by stimulated emission of photons and a pair of electrodes supplying electrical excitation to the active layer when energized. The waveguide amplifier may further include a pair of electrically-insulating cladding layers disposed on opposite sides of the active layer. The cladding layers confine propagating light to the active layer. The waveguide amplifier may further include a low-reflection device facet receiving an optical data signal and directing the optical data signal into at least the active layer for amplification to create an amplified optical data signal and a low reflection output facet directing the amplified optical data signal out of the active layer to the surrounding environment.

The electroluminescent waveguide amplifier (ELWA) of the invention is compact and relies upon electrical excitation, rather than pump light from an optical pumping source, to obtain high gains. This aspect of the invention represents a significant technological advance over conventional EDFA's and EDWA's. The gain medium or host material of ELWA's is easily fabricated as a simple amorphous thin film coating, similar to EDWA's, and does not require the use of sophisticated epitaxial growth techniques as required in the fabrication of SOA's. The gain medium of ELWA's may be electrically pumped (i.e., excited), as are SOA's, which eliminates the need for an optical pump source. The host material of ELWA's has a refractive index appropriate for a waveguide core, is compatible with a waveguide cladding material, and is capable of producing emission from embedded rare earth ions or other luminescent dopants.

The ELWA's of the invention may be fabricated using inorganic host materials for enhanced compatibility with optical fibers formed from inorganic materials (e.g., silica) or organic host materials for enhanced compatibility with optical fibers formed from organic materials (e.g., plastics such as poly-methylmethacrylate (PMMA)). The amplification wavelength in ELWA's is determined by the selection of one or more luminescent dopant(s) and is not restricted by the band-gap of semiconductor material, as is true of SOA's. This represents a significant improvement over conventional SOA's. Furthermore, an ELWA can be designed to have a lower intrinsic optical attenuation than an SOA because an ELWA may rely on a highly-optically transparent material (e.g., oxide glasses, polymers) as a host material for the luminescent dopant.

### BRIEF DESCRIPTION OF THE DRAWINGS

Various advantages, objectives, and features of the invention will become more readily apparent to those of ordinary skill in the art upon review of the following detailed description of the preferred embodiments, taken in conjunction with the accompanying drawings.

FIG. 1 is a schematic cross-sectional view of a semiconductor optical amplifier in accordance with the prior art.

FIG. 2A is a schematic side cross-sectional view of an electroluminescent waveguide amplifier in accordance with the principles of the present invention.

FIG. 2B is a schematic end cross-sectional view of the electroluminescent waveguide amplifier of FIG. 2A.

FIG. 2C is a diagrammatic view illustrating the electronic transition energy levels of the dopant in the active layer and photon emission from

FIG. 3A is a schematic end cross-sectional view of an electroluminescent waveguide amplifier in accordance with an alternative embodiment of the invention.

FIG. 3B is a schematic end cross-sectional view of an electroluminescent waveguide amplifier in accordance with an alternative embodiment of the invention.

FIG. 4 is a schematic view of a platform integrating electroluminescent waveguide amplifiers of the invention with signal monitoring circuitry and waveguide devices.

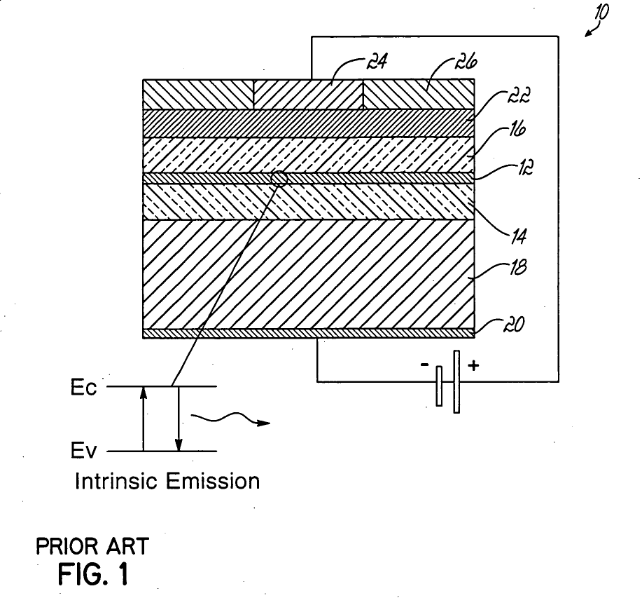

### DETAILED DESCRIPTION

The present invention is directed to an electroluminescent waveguide amplifier that includes an electroluminescent active layer consisting of a host medium doped with luminescent atoms that amplify propagating signal light or optical data signals through stimulated emission and cladding layers disposed between the active layer and the electrodes, which confine propagating light having the form of optical data signals to the active layer and the cladding layers. The characteristics of the cladding layers also permit coupling of electrical excitation from the device electrodes to the active layer.

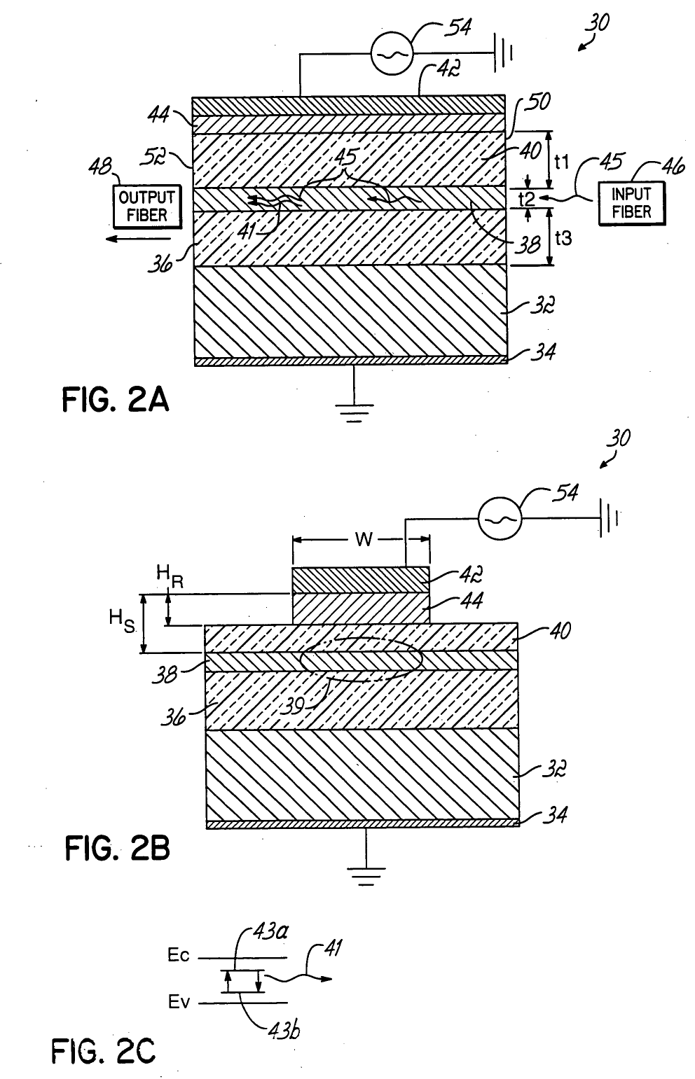

With reference to FIGS. 2A-2B, an electroluminescent waveguide amplifier 30 in accordance with the principles of the invention includes a substrate 32, an electrode 34 applied to one surface of the substrate 32, a lower cladding layer 36 applied to the opposite surface of the substrate 32, an active layer 38 applied on the lower cladding layer 36, an upper cladding layer 40 applied on the active layer 38, and a stripe electrode 42 applied on an upstanding ridge 44 formed in the upper cladding layer 40. The refractive index of the cladding layers 36, 40 is less than the refractive index of the active layer 38.

An input optical fiber 46 (FIG. 2A) supplies optical data signals 45 to the electroluminescent waveguide amplifier 30, which propagate in a confined manner within a confined region 39 bounded by the cladding layers 36, 40 to an output optical fiber 48 (FIG. 2A). The intensity of the optical data signals 45 traveling from the input optical fiber 46 to the output optical fiber 48 is increased or amplified by stimulated emission of photons 41 (FIG. 2C) from the excited state of a dopant present in the host material of the active layer 38.

Although the electroluminescent waveguide amplifier 30 is depicted as having a linear device structure having uniform width features, a person of ordinary skill in the art will appreciate that different device geometries may be utilized. For example, the electroluminescent waveguide amplifier 30 may be implemented in a compact design, such as a coiled geometry, which effectively lengthens the optical path over which light amplification occurs while conserving space on the substrate 32.

With continued reference to FIGS. 2A-2B, the substrate 32 may be any suitable substrate material having a smooth, relatively flat surface finish, such as silicon. Generally, the substrate 32 should be a material in which optical distribution devices, such as splitters, MMI couplers, and arrayed waveguide gratings, may be fabricated. The electrodes 34, 42 are formed from any electrically-conductive material, such as indium-tin-oxide (ITO), aluminum (Al), magnesium (Mg), calcium (Ca), indium (In), or gallium nitride (GaN).

The host material of the active layer 38 may be any low crystallinity, non-crystalline or, preferably, amorphous material that is optically transparent at the amplified wavelength and that is capable of incorporating optically-active luminescent dopant atoms at a concentration effective to produce stimulated light emission of photons 41 at one or more wavelengths due to electronic transitions between energy levels 43a and 43b, as diagrammatically shown in FIG. 2C. In addition, the host material of the active layer 38 must be capable of either transporting electrons or holes as a semiconductor or undergoing electrical breakdown to produce hot electrons or holes, as is characteristic of an insulator, for exciting the luminescence centers supplied by the dopant. The host material of the active layer 38 must also exhibit compatibility with the material constituting the cladding layers 36, 40.

Among the suitable inorganic host materials for active layer 38 are oxides including, but not limited to, ZnSiGeO, SiGeO, BaMgAlO, InGaAlO, and YGeO, sulfides including, but not limited to, ZnMgSSe, SrInAlGaS, and BaInAlGaS, nitrides such as InAlGaN, arsenides such as AlGaAs, phosphides such as InAlGaP, and fluorides including, but not limited to, ZnF, CaF, and GdF. Suitable organic hosts include, but are not limited to, Alq3, poly-pheny-lene (PPP), poly-phenylene-vinylene (PPV), poly(N-vinylcarbazole) (PVK), poly(3-alkylthiophene) (PAT), oligo(p-phenyleneviny-lene) (OPV), and poly(methyl methacrylate) (PMMA). These and other potential organic hosts are described in “The Electroluminescence of Organic Materials” by Ulrich Mitschke and Peter Bäuerle and published in J. Mater. Chem., 2000, 10, 1471-1507, the disclosure of which is hereby incorporated by reference herein in its entirety.

The dopant in the active layer 38 may be any element having electronic transition levels that can result in an inverted population of energy levels at a characteristic wavelength when incorporated into a wide band-gap semiconductor. Suitable dopants for inorganic host materials include elements selected from the Periodic Table, such as elements from the Transition metal series including chromium (Cr), titanium (Ti), manganese (Mn), copper (Cu), zinc (Zn), and silver (Ag), Rare Earth elements from, for example, the Lanthanide metal series including cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), and ytterbium (Yb), and other metals, such as lead (Pb). Typically, the elemental concentration of the dopant in inorganic host materials ranges from a minimum of about 0.1 at. % to a maximum of about 10 at. %. Suitable dopants for inorganic host materials have the form of organic complexes.

A particularly preferred insulating material, that experiences suitable electrical breakdown, is zinc silicate-germanate (Zn₂Si_{0.5}Ge_{0.5}O₄). Erbium as a dopant species in zinc silicate-germanate produces stimulated emission at about 1.55 μm, which is centered on the C-band used in optical fiber telecommunications systems. Similarly, praseodymium as a dopant species in zinc silicate-germanate produces stimulated emission at about 1.3 μm, which is centered on the L-band used in optical fiber telecommunications systems.

With continued reference to FIGS. 2A-2B, the active layer 38 is an amorphous thin film formed by, for example, physical deposition by sputtering or evaporation, laser ablation, or spin-on deposition. The dopant species can be incorporated into the semiconductor material during deposition by in situ methods or introduced into the semiconductor material post-deposition by a conventional technique, such as ion implantation or diffusion. The concentration of the dopant in the active layer 38 may be homogeneous or, in certain embodiments of the invention, may be inhomogenous (e.g., a Gaussian profile) in either the lateral direction parallel to the direction of light propagation or in the transverse direction perpendicular to the direction of light propagation. In addition, the refractive index of the active layer 38 may likewise be inhomogenous in either the lateral or the transverse direction, which may eliminate the necessity of ridge 44 for accomplishing transverse confinement.

The active layer 38 may contain one or more sublayers that guide the propagating optical data signal 45 and/or one or more sublayers that serve the purpose of optical amplification. In particular, the active layer 38 may contain one or more sublayers that serve the purpose of coupling electrical excitation to one or more sublayers that provide optical amplification.

The lower and upper cladding layers 36, 40 are formed from any suitable dielectric material, such as SiO₂, Si₃N₄, BaTiO₃, Y₂O₃, Al₂O₃ or graded index combinations thereof to optimize transmission of the wavelength of optical data signals. The lower and upper cladding layers 36, 40 may also be formed from amorphous organic materials, such as perylenedicarboximide (PBD), Alq3, N,N′-Diphenyl-N,N′-bis(3-methylphenyl)-1,1′-biphenyl-4,4′-diamine (TPD) N,N′-bis(1-naphthyl)-N,N′-diphenyl-1,1′-biphenyl-4,4′-diamine (NPD), poly-pheny-lene) (PPP), poly(N-vinylcarbazole) (PVK), poly(3-alkylthiophene) (PAT), oligo(p-phenyleneviny-lene) (OPV), poly(methyl methacrylate) (PMMA), poly-phenylene-vinylene (PPV), polyacteylene (PA), polyaniline (PAni), polypyrrole (PPy), polythiophene (PT), poly(3,4-ethylenedioxythiophene) (PEDOT), poly(pyridinevinylene) (PPyV), polyquinoxaline (PQx), and poly[2,2′-(p-phenylene)-6,6′-bis(3-phenylquinoxaline)] (PPQ). Amorphous organic materials are suitable for the lower and upper cladding layers 36, 40 if the host material of the active layer 38 is likewise an organic material. The cladding layers 36, 40 may be insulating, semi-insulating or conducting because the electroluminescent waveguide amplifier 30 with an organic host material in active layer 38 would be operated under DC bias.

The refractive index of the lower and upper cladding layers 36, 40 is sufficiently less than the refractive index of the active layer 38 in order to maximize the transmission by preventing interaction with the electrodes 34, 42, which would otherwise operate to attenuate the optical data signal 45 as it propagates through the electroluminescent waveguide amplifier 30. Generally, to provide acceptable isolation, the refractive index of the cladding layers 36, 40 is a range of about 0.1 percent to about 20 percent smaller than the refractive index of the active layer 38. The lower and upper cladding layers 36, 40 may be formed from the same or different dielectric materials or organic materials. The lower and upper cladding layers 36, 40 are characterized by a thickness t3 and t1, respectively, and the active layer 38 has a thickness t2. The lower and upper cladding layers 36, 40 are sufficiently thick (typically about 300 nm to about 1000 nm) to isolate propagating light from the electrodes 34, 42. Of course, the thickness and refractive index collectively determine the isolation effectiveness of the cladding layers 36, 40 for preventing interaction between the propagating light and the electrodes 34, 42.

The lower and upper cladding layers 36, 40 may also be formed by a gas or vacuum gap, which has a low relative permittivity of unity (1) and is less efficient at electrically coupling electric field to the active layer 38. However, a vacuum gap or specialized gas possesses a very low refractive index of 1.0, which allows for strong optical confinement of the optical data signal 45 to the active layer 38. This strong confinement allows the thickness (t1 and t3) of cladding layers 36 and 40 to be decreased, which increases the electrical coupling efficiency of the electric field established between electrodes 34 and 42 to the active layer 38. Furthermore, the gas or vacuum gap may possess extremely high breakdown voltages allowing the waveguide amplifier 30 to be operated at voltages higher than that achievable with solid materials used for cladding layers 36, 40. A gas or vacuum upper cladding layer 40 may also be electrically conducting through electron tunneling or breakdown. At sufficiently high voltages, a cathodoluminescence excitation of the active layer 38 may be achieved.

The lower and upper cladding layers 36, 40 may be electrically conductive under alternating or direct current excitation or, alternatively, only under alternating current excitation. The refractive index and/or the free-carrier density of the lower and upper cladding layers 36, 40 may be inhomogenous in lateral or transverse directions. Preferably, the dielectric constant or relative permittivity of the lower and upper cladding layers 36, 40 is greater than about 20. In addition, the refractive index and/or free carrier density of the lower and upper cladding layers 36, 40 may be inhomogenous in either the lateral or the transverse direction, which may eliminate the necessity of ridge 44 for accomplishing transverse confinement.

As the refractive index increases with increasing dielectric constant, it may be appropriate to form the lower and upper cladding layers 36, 40 from multiple sub-layers of different materials. For example, the lower and upper cladding layers 36, 40 may be formed from two different optically-transparent dielectric materials in which the effective index of refraction provides the desired light guiding effect and the effective dielectric constant is adequate to permit coupling of electrical energy with the active layer 38. For example, a sublayer with a dielectric constant greater than about 20 may be separated from the active layer 38 by another sublayer of SiO₂, which is particularly suitable for cladding ZSG and other oxides. SiO₂ itself has a dielectric constant of only about 3.9. The lower and upper cladding layers 36, 40 may contain one or more sub-layers that optically confine propagating light to the active layer 38 or one or more sub-layers that couple electrical excitation to the active layer 38.

With continued reference to FIGS. 2A-2B, the ridge 44 extends along the length of the active layer 38. Ridge 44 may be defined in the upper cladding layer 40 by standard lithographic techniques that apply a resist layer to the upper cladding layer 40, expose the resist layer to impart a latent image pattern, and develop the resist layer to transform the latent image pattern into a final image pattern having a masked strip that defines the location of the ridge 44. Material in the exposed areas flanking the masked strip is removed by etching, such as by plasma or reactive ion etching, to define the ridge 44. The width, W, of the ridge 44, in relation to its height, is selected in a known manner to ensure transverse confinement of the propagating optical data signals 45. The ridge 44 is preferably equidistant from the lateral edges of the active layer 38.

One or more low-reflection device input facets, generally indicated by reference numeral 50, are provided on a lateral input side of the electroluminescent waveguide amplifier 30. The input optical fiber 46 is optically aligned with the device input facets 50. Similarly, one or more low-reflection device output facets, generally indicated by reference numeral 52, located on an opposite lateral side of the electroluminescent waveguide amplifier 30 to device input facets 50 are optically aligned with the output optical fiber 48. For example, the input and output facets 50, 52 may be covered by corresponding anti-reflection coatings for reducing reflection. The number of output facets 52 may exceed the number of input facets 50, which effectively splits the input optical data signal among multiple outputs. The optical amplification provided by the active layer 38 compensates for signal attenuation due to splitting the input optical data signal among the multiple output facets 52.

The upper cladding layer 40 is characterized by a slab height, H_{S}, and a ridge height, H_{R}, for ridge 44 defining the lateral and transverse boundaries of the optical waveguide. However, the ridge height may have a thickness of zero, depending on the specific embodiment of the amplifier 30. The confinement of the optical signal power is indicated diagrammatically as confined region 39 in FIG. 2B. Although not wanting to be limited by theory, it is believed that the optical waveguide amplifier 30 will support only a single propagating light mode.

In use and with reference to FIGS. 2A-2C, the input optical fiber 46 is aligned optically with the input facet 50 and the output optical fiber 48 is aligned optically with the output facet 52. An AC bias source 54 is electrically coupled across the electrodes 34, 42 of the electroluminescent waveguide amplifier 30. The invention contemplates that a DC bias source could be used as a substitute for AC bias source 54 to energize the electrodes 34, 42 and, thereby, to excite the dopant in the active layer 38. The electroluminescent centers provided by the dopant species in the host material of the active layer 38 are excited, when energized by the AC bias source 54, and an upper impurity level 43a provided by the presence of the electroluminescent impurity in the host material of active layer 38 is populated with electrons. The electrons exist in a metastable state after excitation and provide a population inversion, as indicated diagrammatically in FIG. 2C.

An optical data signal 45, in the form of a string of pulses, is supplied from input optical fiber 46 to the input facet 50. The optical data signal 45 propagates in a confined manner through the active layer 38 and cladding layers 36, 40 to the output optical fiber 48. As best shown in FIG. 2C, the optical data signal 45 stimulate electronic transitions from the populated upper impurity level(s) 43a to previously unpopulated lower impurity level(s) 43b in an abrupt cascade effect, accompanied by the emission of light or photons 41 at a wavelength substantially identical to the wavelength of optical data signal 45 and determined by the energy difference between the upper and lower impurity levels. The photons 41 of emitted light constructively add to the intensity of the input optical data signal 45, so that the total light intensity supplied to the output optical fiber 48 is greater than the input light intensity (i.e., amplified). The electrical excitation provided by the AC bias source 54 creates another population inversion of electrons in the upper dopant energy level(s) 43a awaiting the arrival of another optical data signal 45.

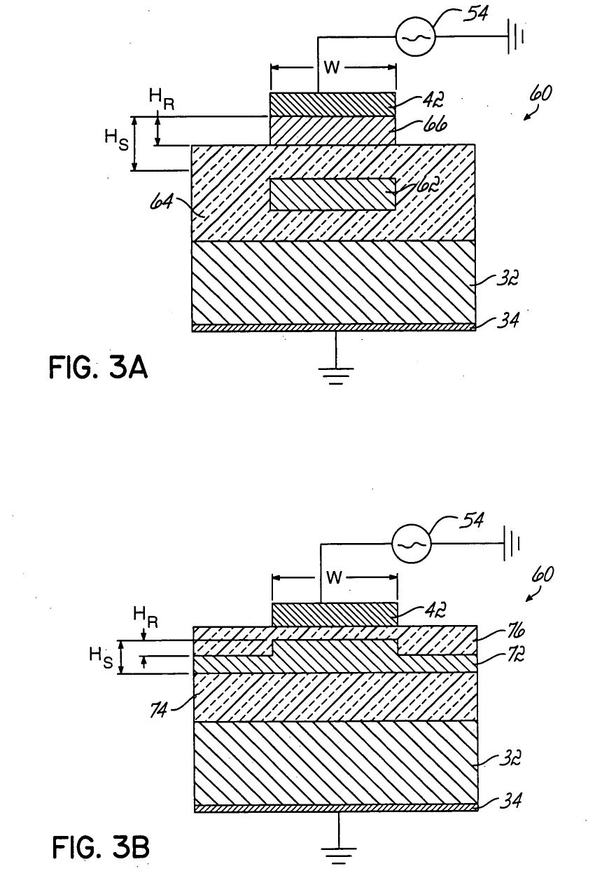

With reference to FIG. 3A in which like reference numerals refer to like features in FIGS. 2A-B and in accordance with an alternative embodiment of the invention, an electroluminescent optical amplifier 60 has an active layer 62 with a refractive index (n2) surrounded on all sides by a single cladding layer 64 of a lower refractive index (n1). An upper surface of the cladding layer 64 is etched to define a ridge 66 to which a stripe electrode 42 is applied or simultaneously defined by the etch. Depending on the specific embodiment of the device, the height of ridge 66 may be zero.

With reference to FIG. 3B in which like reference numerals refer to like features in FIGS. 2A-B and in accordance with an alternative embodiment of the invention, an electroluminescent optical amplifier 70 has an active layer 72 of refractive index n2 deposited on a cladding layer 74 of refractive index n3 and then patterned by lithographic techniques and etched to produce a structure (ridge 78) providing lateral optical confinement. After the active layer 72 is etched, an upper cladding layer 76 of refractive index n1 is applied to the active layer 72 and a stripe electrode 42 is formed on the upper cladding layer 76.

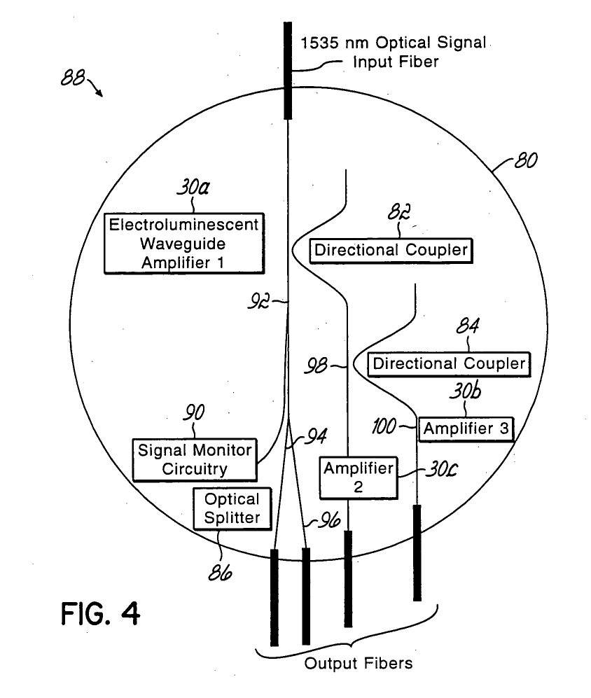

With reference to FIG. 4, multiple electroluminescent optical amplifiers 30a, 30b, 30c, each identical to either optical amplifier 30 (FIGS. 2A,B), optical amplifier 60 (FIG. 3A), or optical amplifier 70 (FIG. 3B), are integrated on a single platform 80 with signal monitoring circuitry and waveguide devices, such as directional couplers 82 and 84 and optical splitters 86, to create a chip-based amplifier 88. The platform 80 may be a semiconductor wafer, such as silicon, or an electrical insulator, such as glass. Signal monitoring circuitry 90 and waveguide devices 92, 94, 96, 98 and 100 are formed in the platform 80 by appropriate fabrication methods. Additional circuitry (not shown) may be included on the platform 80, such as signal filters that reduce undesired propagating wavelength(s) and propagating mode(s).

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept. The scope of the invention itself should only be defined by the appended claims, wherein

We claim:

1. An electroluminescent waveguide amplifier, comprising:
an electroluminescent active layer adapted to propagate light, the active layer including a host medium doped with luminescent dopant atoms capable of amplifying the propagating light by stimulated emission of photons having a wavelength substantially identical to the wavelength of the propagating light; and
a first electrode and a second electrode adapted to collectively supply electrical excitation to the active layer when energized, the active layer being positioned between the first electrode and the second electrode, and the dopant atoms of the active layer responding to the electrical excitation by promoting the stimulated emission of photons.

2. The electroluminescent waveguide amplifier of claim 1 further comprising:
a first cladding layer separating the first electrode from the active layer; and
a second cladding layer separating the second electrode from the active layer, the first and second cladding layers cooperating to confine the propagating light within the active layer and the first and second cladding layers.

3. The electroluminescent waveguide amplifier of claim 2 wherein a refractive index of the first and second cladding layers is less than a refractive index of the active layer.

4. The electroluminescent waveguide amplifier of claim 3 wherein the first and second cladding layers are formed from an electrically-insulating material.

5. The electroluminescent waveguide amplifier of claim 1 wherein the first electrode provides lateral confinement of the propagating light within the active layer in a direction transverse to a direction of light propagation through the active layer.

6. The electroluminescent waveguide amplifier of claim 5 wherein the first electrode has a lateral dimension transverse to the direction of light propagation smaller than a lateral dimension of the active layer.

7. The electroluminescent waveguide amplifier of claim 1 further comprising:
an input facet for receiving the light from a first optical fiber; and
an output facet for directing the amplified light to a second optical fiber, the light propagating in the active layer from the input facet to the output facet.

8. A platform comprising a waveguide device and at least one of the electroluminescent waveguide amplifiers of claim 1 optically coupled with the waveguide device.

9. A method of amplifying an optical data signal, comprising:
directing an optical data signal into a waveguide including an electroluminescent active layer of an electroluminescent waveguide amplifier;
propagating the optical data signal through the waveguide;
amplifying an intensity of the optical data signal by the stimulated emission of photons within the active layer in which the photons have a wavelength substantially identical to a wavelength of the optical data signal; and
directing the amplified optical data signal from the active layer to the surrounding environment.

10. The method of claim 9 wherein amplifying the intensity of the optical data signal further comprises:
electrically exciting luminescent dopant atoms in the active layer to promote stimulated emission of photons capable of amplifying the propagating optical data signal.
